(19) United States
(12) Patent Application Publication
(10) Pub. No.: US 2011/0204609 A1
(43) Pub. Date: Aug. 25, 2011

(54) ANTI FLIPPING MECHANISM

(76) Inventor: Mohamed Ahmed Gad Elkariem, Alexandrea (EG)

(21) Appl. No.: 13/124,329

(22) PCT Filed: Oct. 14, 2009
(86) PCT No.: PCT/EG2009/000027

§ 371 Date: Apr. 14, 2011

(30) Foreign Application Priority Data
Oct. 14, 2008 (EG) 2008101686

(51) Int. Cl. B62D 49/08

(52) U.S. Cl. 280/755

(57) ABSTRACT

Anti Flipping Mechanism is a safety measure used for automobiles. It uses the concept of mechanical vibration damping systems to absorb the shock resulted from automobile tilting around its motion direction line. It uses arms equipped with required springs and absorbers fixed at certain positions on the automobile to prevent it from flipping ensuring passengers' safety.

### TECHNICAL FIELD

Automotive safety measures.

### BACKGROUND ART

Balancing is an essential element of any safe automobile. In case of unbalancing, flipping occurs leading to disastrous results. Flipping accidents of automobiles can be prevented by providing anti flipping mechanism: that prevents any automobile from any sudden flipping or unbalancing around its center of mass due to burst of tires of side, front or rear collisions.

### DISCLOSURE OF INVENTION

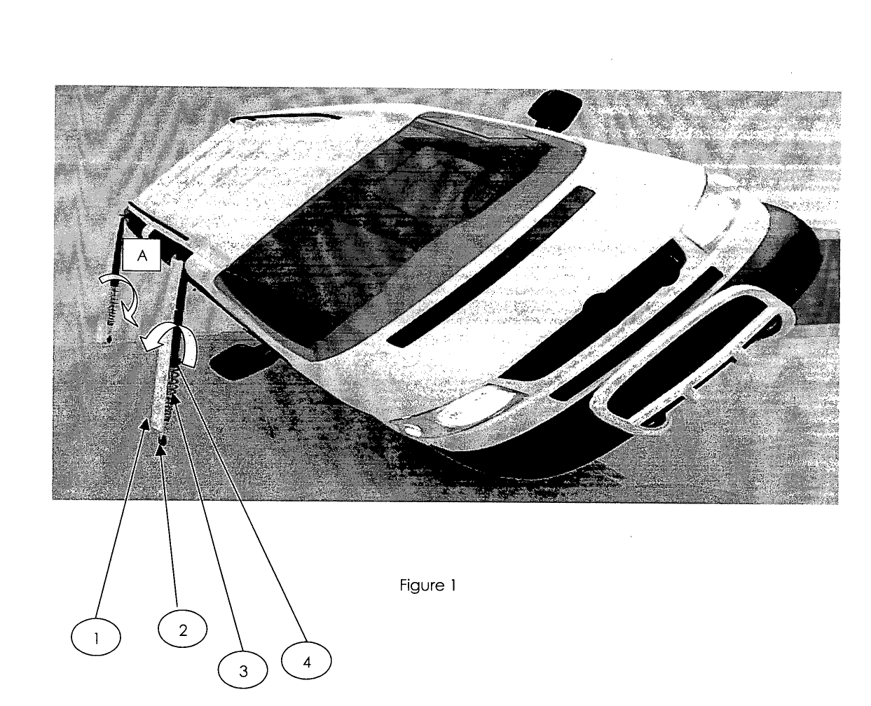

As illustrated in FIG. 1, an arm 1 opens automatically in case of reaching critical limit of automobile unbalancing measured by balancing sensors. Roller support 2 permits the automobile to continue rolling without any sudden stop. Damping system consist of spring 3 and damper 4 absorbs shock resulted from tilting of the automobile.

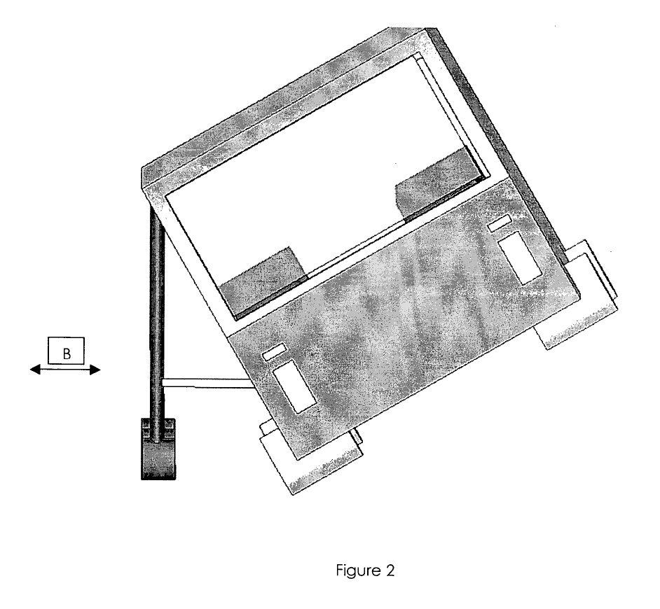

For larger automobile like buses, direction of the opening of the supporting arm is altered from direction A illustrated in FIG. 1 into direction B illustrated in FIG. 2.

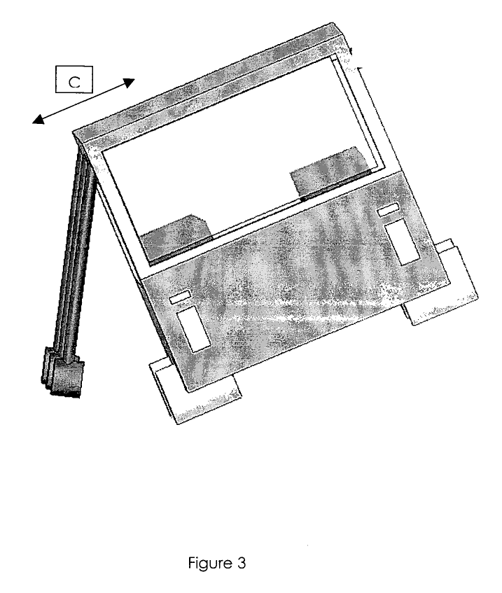

As illustrated in FIG. 3, absorbing arm can be provided at the ceiling of the automobile and can be opened along direction of C.

Complex design of the anti flipping mechanism can be provided by mixing 2 or more designs illustrated in FIGS. 1, 2 and 3.

### BRIEF DESCRIPTION OF DRAWING

1. FIG. 1

Arm 1

Roller support 2

Spring 3

Damper 4 absorbs

2. FIG. 2

For larger automobile like buses, direction of the opening of the supporting arm is altered from direction A illustrated in FIG. 1 into direction B illustrated in FIG. 2.

3. As illustrated in FIG. 3, absorbing arm can be provided at the ceiling of the automobile and can be opened along direction of C.

1. Anti Flipping Mechanism is a set of mechanical elements assembled as vibration damping system consisting of absorbing arm, spring and damper is being actuated automatically by balancing sensors used to prevent automobiles from flipping.

2. Anti Flipping Mechanism, according to claim 1 is being fixed wherever possible at the automobile regarding its geometry and size.
